(19) United States
(12) Patent Application Publication
(10) Pub. No.: US 2016/0284227 A1
(43) Pub. Date: Sep. 29, 2016

(54) Multi-sensory, tactile educational book

(71) Applicant: Karen Fernandez, Carlsbad (YS)

(72) Inventor: Karen Fernandez, Carlsbad (YS)

(21) Appl. No.: 15/079,723

(22) Filed: Mar. 24, 2016

Related U.S. Application Data
(60) Provisional application No. 62/138,111, filed on Mar. 25, 2015.

(51) Int. Cl. G09B 11/04; G09B 19/06

(52) U.S. Cl. CPC G09B 11/04; G09B 19/06

(57) ABSTRACT

This invention is directed toward a multi-sensory educational tool designed to facilitate learning of items such as alphabet letters, numbers, shapes, symbols and foreign language characters through exposing the senses of the learner to a variety of tactile, visual and auditory stimuli.

### CROSS REFERENCE TO RELATED APPLICATIONS

This application claims the benefit of U.S. Provisional Application No. 62/138,111, filed on Mar. 25, 2015, the contents of which are incorporated by reference.

### STATEMENT REGARDING FEDERALLY SPONSORED RESEARCH OR DEVELOPMENT

This invention was not federally sponsored.

### BACKGROUND OF THE INVENTION

### Field of the Invention

This invention relates to the general field of educational books, and more specifically to a book with tactile letters, numbers, shapes or symbols that facilitate a multi-sensory approach to learning. In particular, this application discloses a book with letters, numbers, symbols, shapes or some other desired topic is portrayed where the components of each letter, number or symbol (hereinafter referred to as “item” or “items”) are given tactile characteristics such that in addition to sounding out the item, the learner can physically trace the item based on directions given on the page. Next to each item to trace is a named picture relating to that item, along with a phrase describing the physical directions a finger should take in tracing the item.

For purposes of example, we shall describe in some detail one embodiment of the invention: namely, the lowercase letters of the English alphabet, but it should be understood that the same process behind making such a book and using it to teach students could just as easily be used for numbers, shapes such as squares, rectangles, triangles, circles, ovals, hearts, stars, diamonds, hexagons, etc., symbols, and foreign languages, including those such as Chinese, Japanese, Korean, Thai and numerous Middle Eastern languages that have alphabets dissimilar to those relaying on the Latin alphabet and its derivatives.

The tactile characteristic we shall use as an example shall be raised dots with directional arrows indicating the order in which a user traces the parts of the letter with his or her finger. It should be realized though, that a number of other tactile characteristics and permutations are contemplated that could also allow a user to learn items through this multi-sensory approach. For example, the tactile characteristic could be raised directional arrows that direct a person in how to trace a particular item. Alternatively, dots could be created with several different heights, such that a user could trace the parts of an item with the height of the dots indicating the order of the parts of the item. Another embodiment could have the star, at which the user begins to trace the item, raised or otherwise made more distinctive, or perhaps to have an ending symbol, also raised or otherwise made distinctive.

A primary goal of this invention is to provide an educational tool by which children can learn the alphabet and the proper creation of uppercase and lowercase letters, numbers, shapes, symbols of a person's native language. The process of learning through manually tracing an item and repeating a phrase describing the tracing, however, can also be used in a variety of other situations. For example, the invention could be used by children or adults learning a foreign language using characters not familiar to them; tracing a foreign language character or symbol according to kinesthetically-theorized directions given on the page while reciting the sound the item makes is an excellent way to learn a language. The more ways a person tries to learn a language, the more “brain anchors” are created and the more quickly the language can be learned, thus, combining the sound, the sight, and the physical tracing of the letter produces superior learning results to methods relying upon just one or two of these aspects of learning.

In addition, the invention can be used for people with dexterity challenges, as the tracing of each item practices the hand movements necessary for creating that item later on by writing. Patients suffering from dementia and other mental issues also benefit from the multi-sensory approach to creating and memorizing language items.

The invention is created by selecting a genre of items—such as lowercase English alphabet letters—and selecting a font that lends itself to easily transferring into handwriting. A picture representative of that item is selected along with a written description of the physical movements needed to trace the item in the correct order. On the path of the directed tracing is some sort of tactile object, or series of objects, such that the user of the invention gets a physical response from correctly tracing the intended path. So, for example, the lowercase letter “a” could have an apple as the picture, along with the phrase “a as in apple” with an “a” with raised dots, a star designating the beginning point, arrows to direct the finger on how to move to trace the item, and a phrase such as “around, close, down” to describe the direction of the finger. Studies have shown that tracing a textured letter is an excellent way to gain a muscle memory of the letter as a precursor to writing. Because there are significantly less finger lifts in the types of fonts selected for use in this invention, there is less of a transition to cursive writing. Students exposed to the look and sound of the letter develop a muscle memory of the simple cursive letter as well, which will help them later on as they begin to write.

This invention was created to fill a need in educational books designed to provide a multi-sensory approach to learning. There exist already a number of books designed to teach the alphabet, numbers, etc., but none combine the multi-sensory approach of this invention. For example, there are books with “sandpaper” letters that a student can trace, but there are no directional suggestions. There are also books using raised bumps to allow for tracing of letters, however, these are more of a “connect the dots” layout rather than a continuous tactile series, and there are no descriptive phrases covering the direction a finger takes in tracing the letter.

The prior art also teaches pages with depressions to help with spacing of characters, but these fail to teach the proper writing movements. The prior art also shows a lack of recognition of the benefits of using fonts that have few “finger lifts” during the creation of a letter or number, the more easily the learner of the letter or alphabet will have in recreating that letter or number via cursive writing, which puts a premium on minimizing the number of pen or pencil lifts from the page. The prior art also fails to identify and capitalize on the use of a font which has been proven to facilitate translating the muscle memory from finger movements to eventual cursive writing. In short, while many prior art references teach part of the combination proposed by this invention, none teaches this combination, which has proven extremely successful in teaching people to memorize and reproduce items.

One attempt to use tactile communications is found in U.S. Pat. No. 4,878,844 to Gasper et al. This patent discusses a method of printing small letters that are raised slightly to provide a tactile sensory experience to the user of the invention. The small letters are related to larger letter or character it forms, such as using a hundred or so small “z's” to create a large “Z”, as illustrated in FIG. 3b of the invention. The patent also teaches the use of a small letter that is somehow related to a larger picture, such as the “Z” that is used on a picture of a zipper and the world “zip” in FIG. 3b.

However, this product has a number of limitations. For example, while tracing the shape of the letter may assist in memorizing the letter, there are no “hard skills” being taught, such as learning to write cursive through establishing muscle memory. There are also no directions on how to make the letter, thus while the user may memorize the letter begin taught, he/she will pick up no practical, physical skills associated with actually being able to create the letter.

Thus there has existed a long-felt need for a multi-sensory educational book that effectively teaches items such as letters, numbers and symbols to children and adult learners. The current invention provides just such a solution by having a book where each page combines an item, a picture associated with that item, a phrase describing that item, tactile indicia directing the user how to trace the item, and a memorable phrase describing the movements of the person's finger.

### Objects of the Invention

It is therefore a primary object of the present invention to provide an educational tool where a person can learn a letter, number or symbol through tactile tracing of the item combined with other visual clues.

It is an additional object of the invention to provide a tactile learning tool for people with visual or memory problems, and has proven to be very effective for kids with disabilities such as autism.

Another object of the invention is to teach muscle memory to a person learning the alphabet or numbers, by teaching then the shape of the letter or number with a finger.

A further objection of the invention is to enforce both the physical and mental memory of a letter or number through reinforcement through multiple media

A further object of the invention is to teach penmanship and cursive writing by having a person learning how to write trace each letter or number in a set, specified pattern with a set, specified starting point.

It is another object of the invention to consistently use a single item or shape to locate the starting point for the tracing of a letter or number.

A final object of the invention is to allow for the raised indicia to include symbols like directional arrows and differences in the sizes and/or orientation of projections,

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE FIGURES

One preferred form of the invention will now be described with reference to the accompanying drawings.

FIG. 1 is a top view of a page from a multi-sensory, tactile educational book. according to a preferred form of the invention.

FIG. 2 is a perspective view of a tactile letter with raises bumps and non-raised arrows providing directional guidance.

FIG. 3 is a perspective view a tactile letter with raised arrows providing directional guidance.

FIG. 4 is a perspective view a tactile letter with raised bumps of different sizes providing directional guidance.

FIG. 5 is a top view of how the invention can be used to teach people to create foreign characters.

### DETAILED DESCRIPTION OF THE FIGURES

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

### REFERENCE NUMBERS

1. Definition of item to be taught.
2. Picture of item.
3. Description of memorable phrase describing the path a finger takes in tracing item.
4. Traceable item.
5. Start to mark beginning point.
6. Direction of finger in creating item.
7. Backwards movement of finger.
8. Tactile bump.
9. Tactile arrow.
10. Large tactile bump.
11. Medium tactile bump.
12. Small tactile bump.
13. Left blank.
14. Left blank.
15. Foreign alphabet character, in this case, Japanese character for “a”.
16. Directions for first movement.
17. Directions for second movement.
18. Directions for third movement.
19. Close-up of tactile numbers and tactile arrows.
20. Intersection showing order of movements.

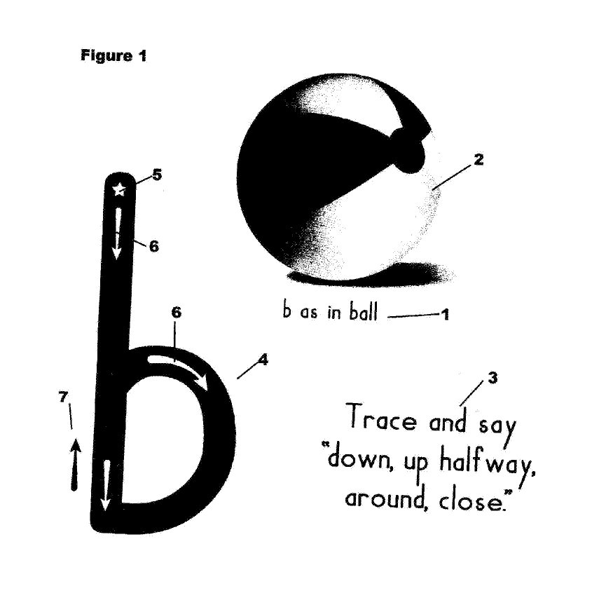

FIG. 1 is a top view of a page from a multi-sensory, tactile educational book, according to a preferred form of the invention. There is an identification of the item 1, in this case, the lowercase letter “b” of the English alphabet. There is also a picture 2 related to the item, in this case a ball. Describing the path that that person's finger takes is a memorable phrase 3 and directions to the user of the invention to trace the item and say aloud the memorable phrase. The item 4, has a star 5 to indicate the starting point, Forward Arrows 6 signifying the direction of finger in creating item and Backward Arrows 7 signifying the backwards movement of finger.

As contrasted with the prior art, the invention as described herein provides a superior method of teaching a person or child how to draw a letter or number. First, because each letter or number in a series has a star, or other symbol to show where to begin the tracing, there is a consistency that a learner can use to always approach learning a letter or number in the proper manner. Second, because the invention lends itself to cursive writing, the memory of an individual letter will lend itself later to handwriting skills. Third, because each letter or symbol comes with oral directions, the learner is reinforced through a combination of multiple senses.

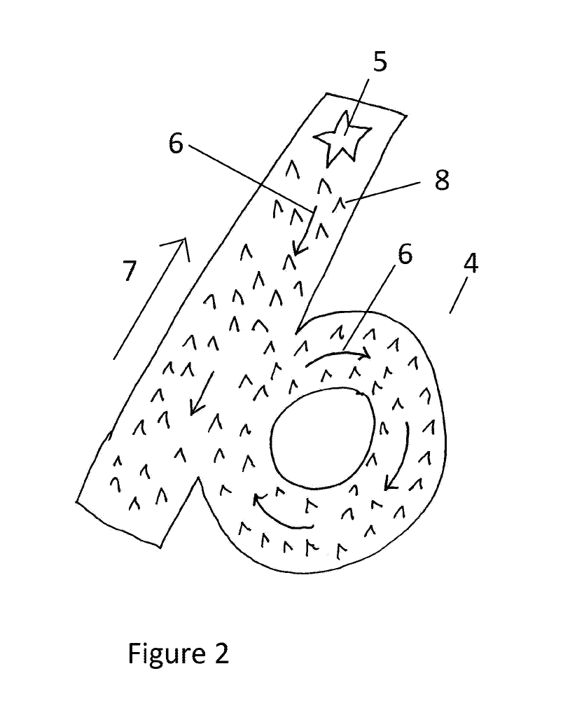

FIG. 2 is a perspective view of a tactile letter item 4 with raised bumps 8 and non-raised arrows, 6 and 7, providing directional guidance. The raised bumps 8 can be felt by the person tracing the item 4. The star 5 tells the user where to start, and the Forward Arrows 6 and Backwards Arrows 7 tell the user what order to move his/her finger to trace the item 4.

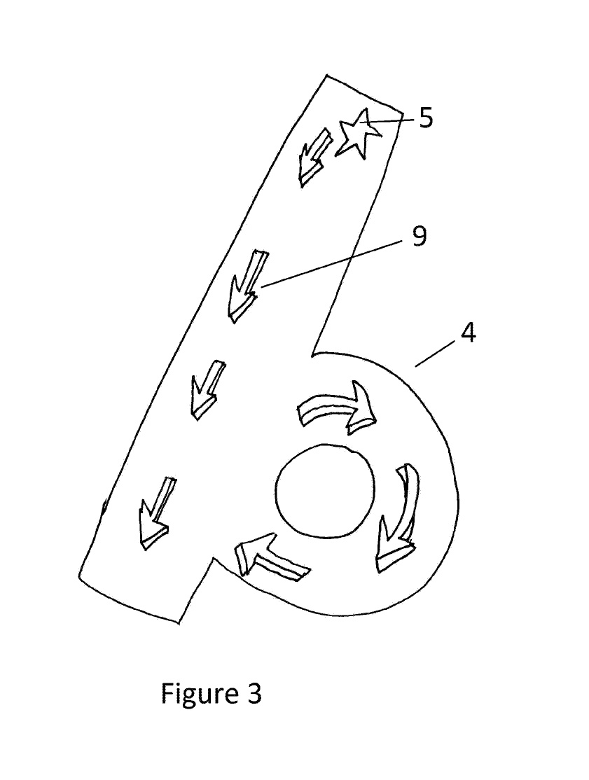

FIG. 3 is a perspective view a tactile letter with raised arrows 9 providing directional guidance. As opposed to the method used in FIG. 2, where non-raised arrows direct the user to follow raised bumps, with this version of the invention the raised arrows provide both direction and tactile feel.

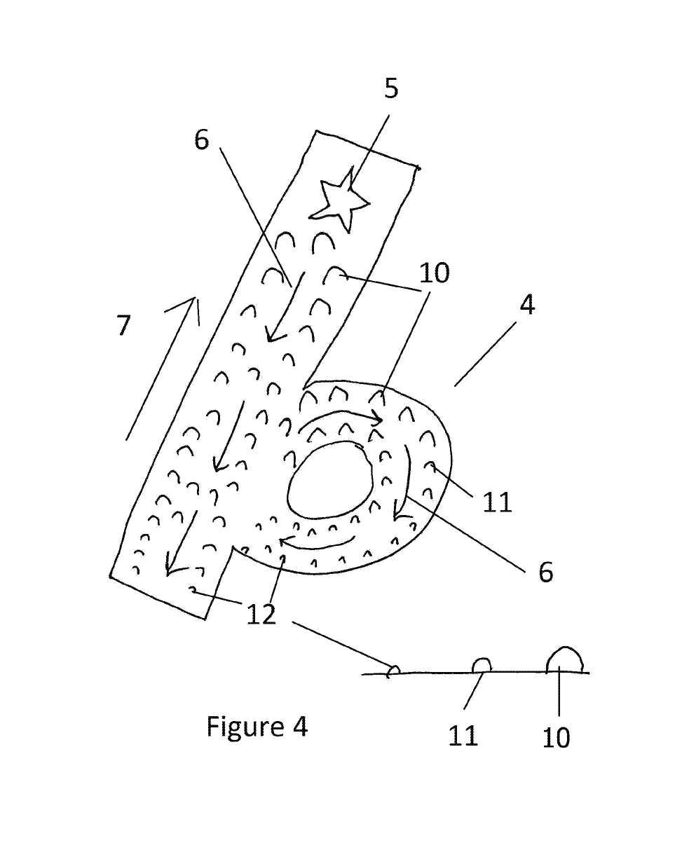

FIG. 4 is a perspective view a tactile letter with raised bumps of different sizes providing directional guidance. As with other embodiments, the star 5 is used to signify the start of the tracing. In this embodiment though, in addition to the directional arrows (6 and 7), there is a gradual change in the size of the bumps, thereby providing an additional tactile facet to the tracing. In this figure, the bumps begin as large bumps 10 where the tracing starts 5, decreasing to medium bumps 11 at the midpoint of the stroke, and ending up as small bumps 12 at the end of the stroke.

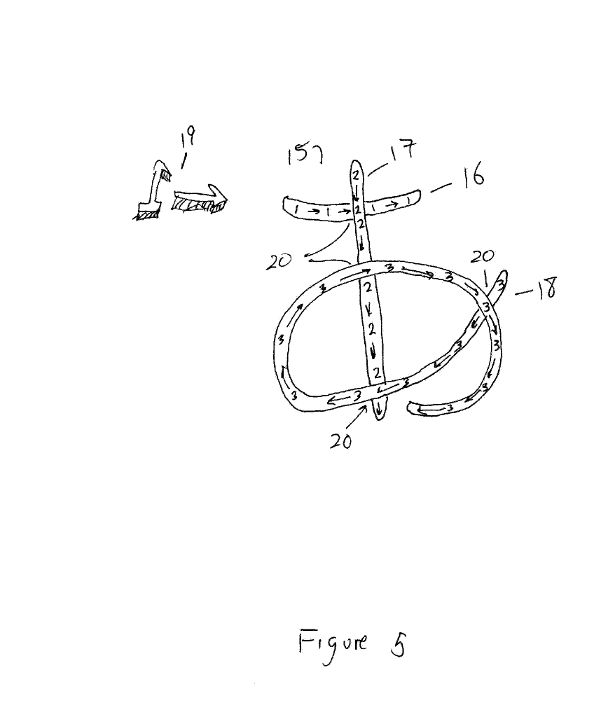

FIG. 5 is a top view of how the invention can be used to teach people to create foreign characters. In this case, the Japanese FIG. 15 for the letter “a” is used. A first stroke 16 is made, following raised numbers and arrows 19, followed by a second stroke 17 and a third stroke 18. At the junctions 20 where the strokes overlap, the numbers and/or arrows of the last stroke override those from any previous strokes, giving the student yet another sensory cue to help him/her remember the correct order taken to create the character. The numbers are used to indicate, in ascending order, the order of strokes in which the user should trace.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

That which is claimed:

1. A teaching device comprising a traceable item, a picture, and a phrase,
where the traceable item represents a character, where the traceable item comprises a plurality of raised elements, where the raised elements comprise a starting symbol and a plurality of bumps, where the starting symbol is placed in a position on the traceable item where a user should begin tracing, where the bumps comprise bumps of different sizes, whereby the bumps of different sizes indicate a direction of movement to be performed by the user tracing the character represented by the traceable item;
where the picture is related to the traceable item; and
where the phrase describes a path the user should trace of the traceable item.

2. The device of claim 1, wherein the bumps of different sizes are larger where the user is to begin tracing the traceable item, and wherein the bumps of different sizes are smaller where the user is to end tracing the traceable item.

3. The device of claim 1, wherein the bumps of different sizes are largest where the user is to begin tracing the traceable item and decrease in size until the bumps of different sizes are smallest where the user is to end tracing the traceable item.

4. The device of claim 1, wherein the bumps of differences sizes comprise large tactile bumps, medium tactile bumps, and small tactile bumps, where the large tactile bumps are located where the user is to begin tracing the traceable item, where the small tactile bumps are located where the user is to end tracing the traceable item, and where the medium tactile bumps are located between the large tactile bumps and the small tactile bumps.

5. The device of claim 1, wherein the traceable item further comprises arrows, where the arrows indicate the direction the user should trace the traceable item.

6. The device of claim 5, wherein the arrows are raised elements.

7. The device of claim 1, where the traceable item has an order in which it should be traced, wherein the traceable item further comprises numbers, where the numbers indicate, in ascending order, the order in which the traceable item should be traced.

8. The device of claim 1, wherein the traceable item is a non-Latin alphabet character.

9. A teaching device comprising a traceable item, a picture, and a phrase,
where the traceable item represents a character, where the traceable item comprises a plurality of raised elements, where the raised elements comprise a starting symbol and a plurality of arrows, where the starting symbol is placed in a position on the traceable item where a user should begin tracing, where the arrows indicate a direction of movement to be performed by the user tracing the traceable item;
where the picture is related to the traceable item; and
where the phrase describes a path the user should trace of the traceable item.

10. The device of claim 9, wherein the raised elements further comprise a plurality of bumps, where the bumps are distributed throughout the traceable item.

11. The device of claim 10, wherein the bumps comprise bumps of different sizes.

12. The device of claim 11, where the bumps of different sizes are larger where the user is to begin tracing the traceable item, and wherein the bumps of different sizes are smaller where the user is to end tracing the traceable item.

13. The device of claim 11, wherein the bumps of different sizes are largest where the user is to begin tracing the traceable item and decrease in size until the bumps of different sizes are smallest where the user is to end tracing the traceable item.

14. The device of claim 11, wherein the bumps of differences sizes comprise large tactile bumps, medium tactile bumps, and small tactile bumps, where the large tactile bumps are located where the user is to begin tracing the traceable item, where the small tactile bumps are located where the user is to end tracing the traceable items, and where the medium tactile bumps are located between the large tactile bumps and the small tactile bumps.

15. The device of claim 9, where the traceable item has an order in which it should be traced, wherein the traceable item further comprises numbers, where the numbers indicate, in ascending order, the order in which the traceable item should be traced.

16. The device of claim 9, wherein the traceable item is a non-Latin alphabet character.

17. A book for teaching characters of an alphabet or language, where the book comprises pages, where at least some of the pages each comprise a traceable item, a picture, and a phrase;
where the traceable item represents a character, where the traceable item comprises a plurality of raised elements, where the raised elements comprise a starting symbol, a plurality of arrows, and a plurality of bumps;
where the starting symbol is placed in a position on the traceable item where a user should begin tracing;
where the arrows indicate a direction of movement to be performed by the user tracing the character represented by the traceable item;
wherein the bumps comprises bumps of different sizes, where the bumps of different sizes are larger where the user is to begin tracing the traceable item, and wherein the bumps of different sizes are smaller where the user is to end tracing the traceable item, thereby indicated the direction the user should trace the traceable item;
where the picture is related to the traceable item; and
where the phrase describes a path the user should trace of the traceable item.

18. The device of claim 17, where the bumps are distributed throughout the traceable item.

19. The device of claim 17, where the traceable item has an order in which it should be traced, wherein the traceable item further comprises numbers, where the numbers indicate, in ascending order, the order in which the traceable item should be traced.

20. The device of claim 17, wherein the starting symbol is a raised star.
